(19) United States
(12) Patent Application Publication
(10) Pub. No.: US 2007/0096930 A1
(43) Pub. Date: May 3, 2007

(54) System and method for detecting proper cleaning of people and items entering a controlled area

(76) Inventor: Joseph Cardoso, Freeport, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(21) Appl. No.: 11/265,022

(22) Filed: Nov. 2, 2005

(51) Int. Cl. G08B 13/14; G08B 23/00

(52) U.S. Cl. 340/573.4; 340/572.1

(57) ABSTRACT

The present invention provides a non-intrusive technique for determining whether people and items have been properly cleaned before entering a controlled area. In one embodiment, soap is provided in washrooms, restrooms, sculleries, or other types of facilities for cleaning people and items entering a controlled area. A sensor detects the presence of metallic or other constituents of the soap left behind on the people and items after proper cleaning. The sensor's output is read to determine whether the people and items have been recently cleaned. Specific people and items can be identified by detecting a signal from a device, such as a radio frequency identification tag, attached to people and items entering a controlled area. For people, the tag can be incorporated into a name badge or into work clothing.

### TECHNICAL FIELD

The present invention relates generally to cleaning people and items entering a controlled area and, more particularly, to determining whether such people and items have been properly cleaned.

### BACKGROUND OF THE INVENTION

In the food processing and serving industry, it is important to ensure that food workers have properly cleansed themselves, such as by washing their hands after using a wash room, in order to ensure consumers' safety and to meet applicable government standards. Maintaining acceptable levels of personal hygiene is also important in certain manufacturing. processes for commercial, industrial, and military equipment in order to preclude contamination that could render the manufactured products unsuitable or unsafe for their intended uses. Training workers in the methods of proper hygiene and monitoring their compliance have become vital aspects of these industries.

Monitoring methods of personal hygiene, such as hand washing, is difficult to accomplish in an effective and non-intrusive manner. Surveillance cameras and people stationed to watch for employees' compliance with personal hygiene requirements are often considered to be intrusions on privacy, particularly where the people watched include non-employees such as restaurant patrons using a wash room. Other existing techniques for monitoring compliance are often very expensive in terms of capital investment and of personnel costs.

The same problems of enforcing and monitoring cleanliness standards apply as well to items brought into a controlled or “clean” area in a manufacturing environment.

### SUMMARY OF THE INVENTION

In view of the foregoing, the present invention provides a non-intrusive technique for determining whether people and items have been properly cleaned before entering a controlled area.

In one embodiment, soap is provided in washrooms, restrooms, sculleries, or other types of facilities for cleaning people and items entering a controlled area. A sensor detects the presence of metallic or other constituents of the soap left behind on the people and items after proper cleaning. The sensor's output is read to determine whether the people and items have been recently cleaned.

Specific people and items can be identified by detecting a signal from a device, such as a radio frequency identification (“RFID”) tag, attached to people and items entering a controlled area. For people, the tag can be incorporated into a name badge or into work clothing.

### BRIEF DESCRIPTION OF THE DRAWINGS

While the appended claims set forth features of the present invention, the invention, together with its objects and advantages, may be best understood from the following detailed description taken in conjunction with the accompanying drawings of which:

FIG. 1 is a perspective illustration of a system, according to an exemplary embodiment of the present invention, for detecting whether a person has properly cleaned his hands after using a wash room; and

FIG. 2 is a flowchart of a method for training employees to comply with personal hygiene requirements.

### DETAILED DESCRIPTION OF THE INVENTION

The following description is based on illustrative embodiments of the invention and should not be taken as limiting the invention with regard to alternative embodiments that are not explicitly described herein.

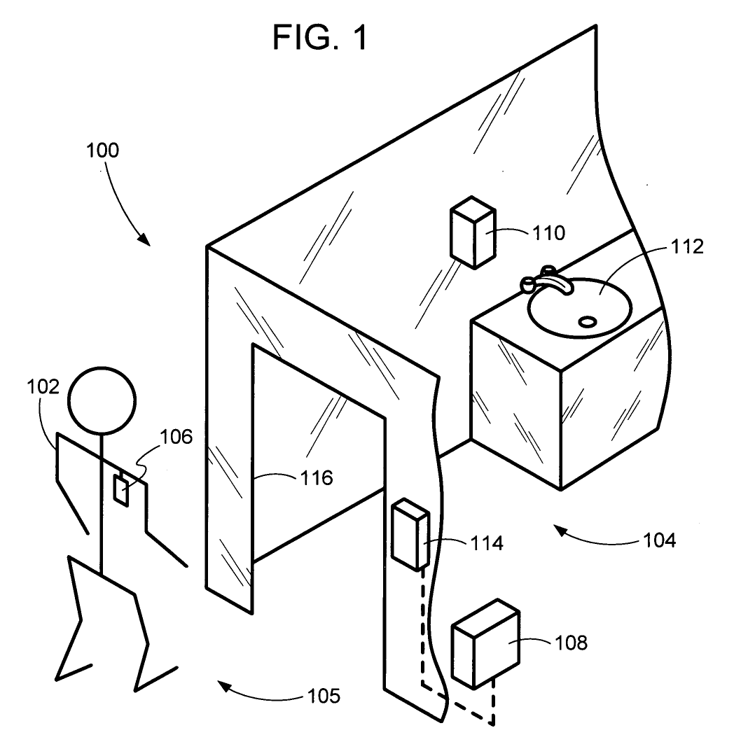

FIG. 1 shows an exemplary system 100 for monitoring compliance with personal hygiene requirements. A person to be monitored 102 is issued a name badge or an item of clothing such as a chefs hat that includes an RFID tag 106, similar to those used for preventing theft in retail stores. When the RFID tag 106 is carried near an electronic sensor 114 at the entrance 116 to a wash room 104, the RFID tag 106 emits a unique signal. The signal is detected by the sensor 114, and a record is entered into a database 108. In that database 108, the identity of the person 102 is correlated with the unique signal of the RFID tag 106.

In the exemplary wash room 104 of FIG. 1, a soap dispenser 110, located near a washbasin 112, dispenses soap containing a metallic element to be detected. In addition to detecting the signal from the RFID tag 106, the electronic sensor 114 can detect the presence of the soap's metallic element.

As the person 102 wearing the RFID tag 106 approaches the entrance 116 of the wash room 104, the electronic sensor 114 detects the signal from the RFID tag 106. A record is entered into the database 108 noting the entrance of this particular person 102 into the wash room 104. After using the wash room 104, the person 102 washes his hands with the specially formulated soap containing the metallic element and exits the wash room 104.

When the person 102 leaves the wash room 104 through the entrance 116, the sensor 114 again detects the RFID tag 106. If the person 102 has properly washed his hands, then the sensor 114 also detects the presence of the soap's metallic element on the hands of the person 102. An entry is made in the database 108 recording both the exit of the person 102 and whether or not the soap's metallic element was detected. If an exit from the wash room 104 is recorded without a detection of the soap's metallic component, then a report is generated to that effect noting the identity of the person 102 to whom the RFID tag 106 has been assigned. The report indicates that the person 102 entered the controlled area 105 outside of the wash room 104 without properly washing his hands. Management reads the report and either further instructs the person 102 in required hygiene procedures or takes disciplinary action.

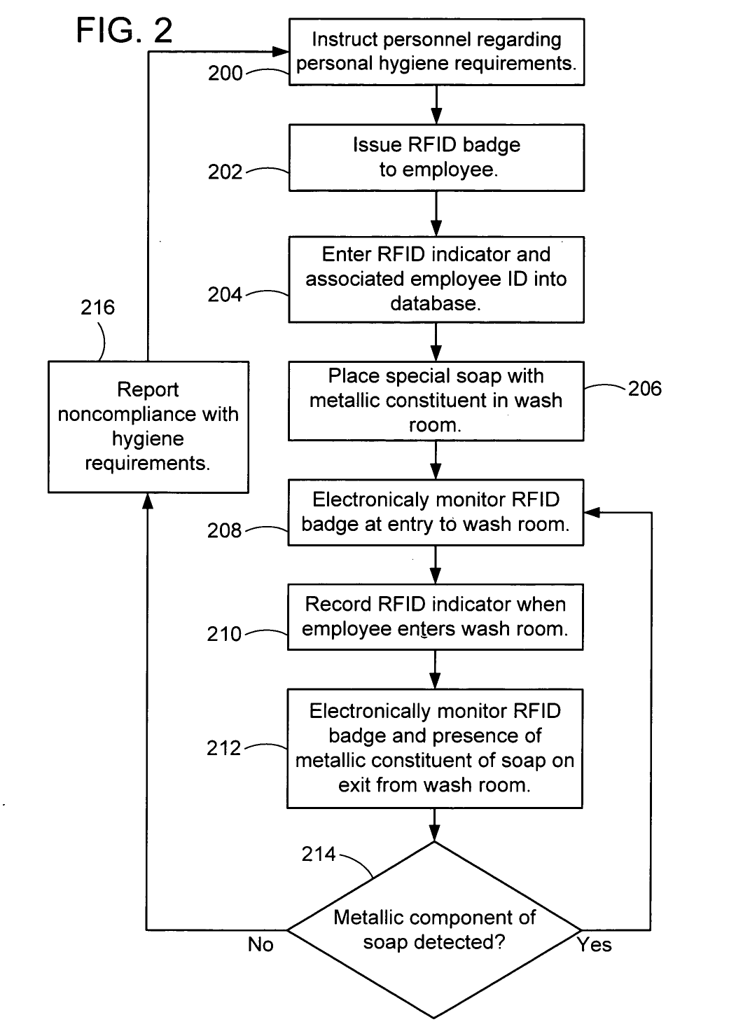

FIG. 2 shows an exemplary method, according to the present invention, for monitoring compliance with personal hygiene requirements. In step 200, people to be monitored 102 are instructed in the requirements of personal hygiene, such as, for example, thoroughly washing their hands with soap after using a wash room 104 and before entering a controlled area 105.

A unique RFID tag 106 is assigned to each person 102 in step 202, and, in step 204, the assignment of a particular RFID tag 106 to a particular person 102 is recorded in a database 108.

In step 206, the wash room 104 is provided with soap containing an element detectable by an electronic sensor 114.

In step 208, the electronic sensor 114 detects the RFID tag 106 when the person 102 wearing it enters the wash room 104. A record to that effect is made in the database 108 in step 210. When the person 102 leaves the wash room 104 in step 212, this is detected by the electronic sensor 114 which also attempts to detect the presence of the specially formulated soap.

If the soap was detected, then the procedure of FIG. 2 simply continues to monitor by returning from step 214 to step 208. If, on the other hand, no soap was detected, then a report to that effect is generated in step 216. Upon reading that report, management may decide that further training in personal hygiene is needed, and the method returns to step 200.

For privacy's sake, in some embodiments of step 214 when the database 108 receives a signal indicating that the person 102 left the wash room 104 with properly washed hands, the database 108 erases the records of that visit to the wash room 104. In other embodiments, the records are retained to show, for example, whether the person 102 properly washed his hands at the start or the end of a work shift, prior to entering the controlled area 105, or periodically during a work shift.

Those having skill in the art are aware that soaps used for cleaning hands or other items generally do not include metallic elements. Certain medicinal soaps, commonly used to treat skin disorders such as eczema and psoriasis, presently contain minute amounts of metallic constituents such as zinc and chromium. The concentration of such metallic constituents is generally kept small, however (sixteen parts per million, for example), to minimize the cost of the soap and for environmental concerns. In one embodiment of the invention, soaps having such metallic components are used in applications where they have not previously been used, such as for washing hands or other items. It is contemplated that, in addition to the metallic constituents previously used in medicinal soaps, other metallic constituents, such as magnesium, can be used with efficacy in practicing the invention.

Although it is contemplated that the electronic sensor 114 is sensitive enough to detect a residue of such metallic elements in the minute amounts presently used by soap manufacturers, it is also contemplated that it may be desirable to use a specially formulated soap that has a higher concentration of such metallic elements to facilitate detection. Any additional cost for increasing the concentration of the metallic constituents would likely be de minimus in comparison to the savings provided by a method or system according to the present invention, especially when compared to previously available alternatives for monitoring compliance with hygiene requirements. The concentrations required for sensing are so small that no environmental concerns are raised by increasing the concentration slightly.

It is also contemplated that the electronic sensor 114 is sophisticated enough to detect a particular metallic element or compound to ascertain that the metallic component detected by the electronic sensor 114 did indeed come from the particular soap provided for cleansing and is not a residue of a previous cleaning with another soap. It is further contemplated that non-metallic constituents can be used in practicing the present invention, for example, constituents detectable by sensors 114 sensitive to infra-red or ultra-violet light. Such other detectable constituents can be used alone or in conjunction with metallic constituents.

It is still further contemplated that a system or method, according to the present invention, may determine which direction the person being monitored 102 is traveling when he passes the sensor 114, so that if two people are passing the sensor 114 in close proximity, i.e., one person enters the wash room 104 at the same time another person exits, then the system 100 discerns between the two and detects whether the person entering the controlled area 105 has used the soap provided for cleaning.

In view of the many possible embodiments to which the principles of the present invention may be applied, it should be recognized that the embodiments described herein with respect to the drawing figures are meant to be illustrative only and should not be taken as limiting the scope of the invention. Those of skill in the art will recognize that some implementation details are determined by specific situations. Therefore, the invention as described herein contemplates all such embodiments as may come within the scope of the following claims and equivalents thereof.

We claim:

1. A method for determining whether an item has been washed prior to entering a controlled area, the method comprising:
physically associating the item with an RFID tag;
logically associating an identity of the item with an identity of the RFID tag;
detecting a presence of the RFID tag when the item enters the controlled area; and
attempting to detect a presence of soap residue when the item enters the controlled area.

2. The method of claim 1 wherein the item is a person, and wherein physically associating the item with an RFID tag comprises having the person carry or wear the RFID tag.

3. The method of claim 2 wherein the controlled area comprises an area outside of a wash room, the method further comprising:
detecting a presence of the RFID tag when the person enters the wash room.

4. The method of claim 3 further comprising:
if attempting to detect a presence of soap residue when the item enters the controlled area succeeds, then erasing a record of the detecting steps.

5. The method of claim 1 wherein logically associating an identity of the item with an identity of the RFID tag comprises making an entry in a database.

6. The method of claim 1 further comprising:
providing soap specially formulated to facilitate detection of residue.

7. The method of claim 1 further comprising:
if attempting to detect a presence of soap residue when the item enters the controlled area fails, then reporting the failure.

8. A system for determining whether an item has been washed prior to entering a controlled area, the system comprising:
an RFID tag physically associated with the item;
logic configured for logically associating an identity of the item with an identity of the RFID tag;
a first sensor configured for detecting a presence of the RFID tag when the item enters the controlled area; and
a second sensor configured for detecting a presence of soap residue when the item enters the controlled area.

9. The system of claim 8 wherein the item is a person, and wherein an RFID tag is physically associated with the item when the person carries or wears the RFID tag.

10. The system of claim 9 wherein the controlled area comprises an area outside of a wash room, and wherein the first sensor is further configured for detecting a presence of the RFID tag when the person enters the wash room.

11. The system of claim 10 further comprising:
logic for erasing records of the detections of the first and second sensors if the second sensor detects a presence of soap residue when the item enters the controlled area.

12. The system of claim 8 wherein the logic configured for logically associating an identity of the item with an identity of the RFID tag is further configured for making an entry in a database.

13. The system of claim 8 further comprising:
soap specially formulated to facilitate detection of residue.

14. The system of claim 8 further comprising:
logic configured for generating a report if the second sensor fails to detect a presence of soap residue when the item enters the controlled area.

15. The system of claim 8 wherein the first and the second sensors are the same sensor.

16. A method for teaching a person to wash his hands, the method comprising:
physically associating the person with an RFID tag;
logically associating an identity of the person with an identity of the RFID tag;
detecting a presence of the RFID tag when the person enters or leaves a wash room;
attempting to detect a presence of soap residue when the person leaves the wash room;
reporting if the person is detected leaving the wash room without detecting the presence of soap residue; and
in response to the report, instructing the person in personal hygiene.

17. The method of claim 16 wherein physically associating the person with an RFID tag comprises having the person carry or wear the RFID tag.

18. The method of claim 16 further comprising:
if attempting to detect a presence of soap residue when the person leaves the wash room succeeds, then erasing a record of the detecting steps.

19. The method of claim 16 wherein logically associating an identity of the person with an identity of the RFID tag comprises making an entry in a database.

20. The method of claim 16 further comprising:
providing soap specially formulated to facilitate detection of residue.
